(19) United States
(12) Patent Application Publication
(10) Pub. No.: US 2010/0023690 A1
(43) Pub. Date: Jan. 28, 2010

(54) CACHING DYNAMIC CONTENTS AND USING A REPLACEMENT OPERATION TO REDUCE THE CREATION/DELETION TIME ASSOCIATED WITH HTML ELEMENTS

(75) Inventors: AMY H. DEWAR, DURHAM, NC (US); ROBERT C. LEAH, CARY, NC (US); NICHOLAS E. POORE, DURHAM, NC (US); PETER C. YIM, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/177,726

(22) Filed: Jul. 22, 2008

(51) Int. Cl. G06F 12/00

(52) U.S. Cl. 711/118; 711/E12.001

(57) ABSTRACT

An event to delete a structured object of a Web page rendered in a browser can be detected. The structured object comprises an HTML element set that was dynamically created for the Web page. The structured object can be placed in a cache without deleting memory allocations for the structured object. An event to dynamically create a new object of the Web page can be detected. The cache can be queried to find an object with structure equivalent to that of the new object. The found object can be taken from the cache and used as the new object after content of the cached object is replaced with that needed for the new object. Memory allocation and deallocation costs that would otherwise be needed to dispose of a dynamic HTML element set and to create a new HTML element set are thus saved using the cache.

### BACKGROUND OF THE INVENTION

The present invention relates to the field of dynamic web content manipulations, more particularly to caching dynamic contents to reduce the creation time of HTML elements.

Many web pages (e.g., Mashups) use dynamic code (e.g., JAVASCRIPT) to dynamically set, update, and delete Hypertext Markup Language (HTML) content. Performance can degrade, however, when significant quantities of Web elements are created and destroyed, which consumes significant computing resources and decreases a user's experience.

For example, assume a JAVASCRIPT executes that needs to create 15,000 HTML elements. A reasonable creation time (based upon a test scenario executed on a reference machine) for these elements can be 250 ms. When dynamic code destroys (frees) those 15,000 elements, an additional time of approximately 14,703 ms can be expected. A total time to create and destroy the 15,000 elements is 14,922 ms. Any solution that minimized creation/destroying operations would save significant time and computing resources. The times provided in the example above were generated using a reference machine. Times to delete and recreate HTML elements are expected to vary by browser type and version (e.g., INTERNET EXPLORER, FIREFOX, SAFARI, etc.), by operating system, by volatile memory quantity and type, and by other implementation specific factors. Regardless of exact times attributable to deleting and recreating HTML elements, these operations consume system resources and incur significant processing time expenditures.

Many types of inherently dynamic Web pages, such as Mashups, are particularly sensitive to element creation/destruction costs. A Mashup can contain a set of Widgets, where widgets can be portable chunks of code able to be installed and executed within any separate HTML (Hypertext Markup Language) based web page. These portable chunks of code can enable additional functionality for a user, or pull content from an external source for display. For example, a widget can allow a user to interact with an electronic mail account. Another widget can pull the latest sports scores from a sports news provider and display the information for the user. Multiple widgets are commonly displayed at the same time, on a customizable web interface. Many of these web interfaces allow users to rearrange the widgets and close or add more.

When widgets are added to the page, a client-side scripting language (i.e. JAVASCRIPT) is commonly used to dynamically update the page without reloading it. When a client-side language is used, the language creates new HTML elements in memory to add to the web page. Creating and destroying many HTML elements in memory can take a significant amount of time, as noted above. In some cases, a user can close a widget that is in their session and re-add the widget later. In this case, the HTML elements contained in the widget would be destroyed when the widget is closed, and a new widget would be created when it is re-added. Cyclically creating and destroying widgets (or any set of dynamic HTML elements) is extremely inefficient.

No effective solutions are currently known to solve problems with excessive HTML element creation/deletion operations, although a number of solutions have been attempted. For example, one known by AJAXIAN (http://ajaxian.com/archives/replacementhtml-for-when-innerhtml-dogs-you-down#comments) proposes to use a JAVASCRIPT “replace” function to modify an HTML element to contain new data instead of deleting an old element and then creating a new one. Known applications of this technique, however, assume that a new element is to be created at a time an old element is to be deleted, which is a special case situation. More often, applications may need to remove a block of HTML code via JAVASCRIPT before deleting a parent element by the application is often not immediately ready to update the parent element with new information to be displayed to a user. That is, a known application of the replace function to minimize creation/delete operations has an immediate effect upon content rendered within an interface and presented to a user.

### BRIEF DESCRIPTION OF THE SEVERAL VIEWS OF THE DRAWINGS

FIG. 1 is a schematic diagram of a system for caching re-usable dynamic Web objects to optimize performance by reducing a number of creation/deletion memory operations for HTML elements in accordance with an embodiment of the inventive arrangements disclosed herein.

FIG. 2 illustrates interfaces for caching parent objects to reduce the creation/deletion time of HTML elements in accordance with an embodiment of the inventive arrangements disclosed herein.

FIG. 3 is a flow chart of a method for caching dynamically created Web objects contents to improve performance in accordance with an embodiment of the inventive arrangements disclosed herein.

### DETAILED DESCRIPTION OF THE INVENTION

The present invention can enable caching of dynamic content to reduce the creation/deletion time of HTML elements. When a user removes dynamic content (set of dynamically created HTML elements) from their session, at least a portion of the content can be transferred to a cache for later use rather than destroyed. When the dynamic content is a structured object containing content, the content and structure can be bifurcated. For example, the content can be discarded, but the structure can be placed in the cache rather than being destroyed. When a system needs a new set (one or more) of dynamic HTML elements, the cache can be queried for objects of that type. When such an object exists, it can be utilized rather than creating a new structural object. When no object is cached, a new structural object can be created. Using the existing object can make use of a content replacing function (e.g., JAVASCRIPT's replace function). The use of the dynamic content cache for structural elements can be implemented in a manner transparent to users (and even to Web developers); yet can result in substantial performance gains.

Numerous techniques can be used to determine a hold duration in the dynamic cache, different ones of which can be implemented depending upon implementation specific conditions. In one embodiment, for example, the cached content can be saved for a fixed, configurable length of time. In another embodiment, operations can execute that attempt to automatically determine how long to save certain content depending on a determined possibility the content will be used again.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

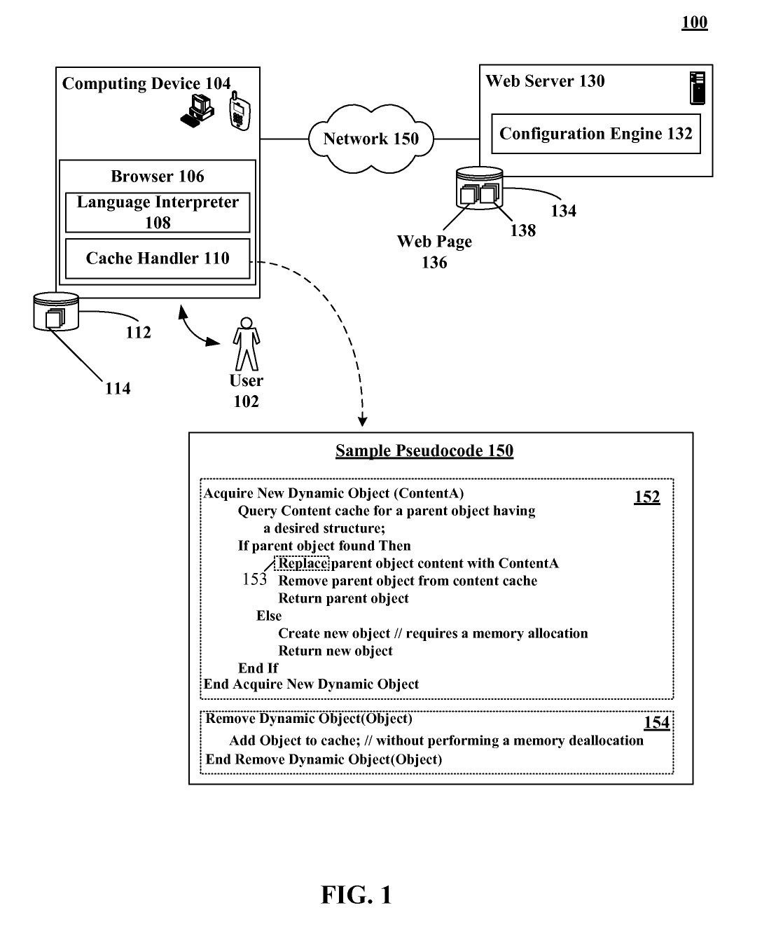

FIG. 1 is a schematic diagram of a system 100 for caching re-usable dynamic Web objects to optimize performance by reducing a number of creation/deletion memory operations for HTML elements in accordance with an embodiment of the inventive arrangements disclosed herein.

System 100 can include user 102, who can establish a web session with web server 130 using browser 106 on computing device 104. User 102's web session can include multiple dynamically created objects displayed on a single web page. For example, the Web page can be a Mashup and the dynamically created objects can include Widgets. The objects can be created using an executable 138, such as a JAVASCRIPT executable, contained within the served Web page 136. Browser 106's language interpreter 108 can receive client-side executable code from web server 130 to execute for user 102's web session. The received client-side executable code can include cache handler 110. In one embodiment, cache handler 110 can be built-in to language interpreter 108 and can manage reconfigurable web content (i.e. content that can be added and/or removed). In another embodiment, functionality of the cache handler 110 can be performed, at least in part, by code of the executable 138.

The cache handler 110 minimizes a number of creation and deletion operations performed when processing dynamic HTML objects. More specifically, the cache handler 110 optimizes performance by minimizing the number of needed memory allocation/deallocation operations for dynamic HTML elements. The optimization is accomplished by saving structured objects 114 in a data store 112. Normally, these structured objects 114 would otherwise be deleted, which would incur a deallocation memory operation cost. System 100 instead recycles these stored objects 114 for use when an object of similar structure is needed (recycling also saves on object creation operations as no new memory allocation operation is needed when using a pool of recycled objects). The structured objects 114 can be referred to as parent objects. Original content included within the structure of a parent object 114 is extraneous and may be either discarded before storage in data store 112 or may be effectively ignored, as it will be replaced with new content should the stored parent object 114 be reused.

Sample pseudocode 150 illustrates a couple of possible computing functions 152, 154 that the cache handler 110 can utilize. Function 152 can be used to acquire a new dynamic object, which can be utilized instead of a create element function. Function 152 queries content cache 112 for a parent object having a desired structure. If one exists, then ContentA is placed in the parent object, the parent object can be removed from the content cache 112 and returned as the “new” object. In one embodiment, a JAVASCRIPT “replace” method can be called with the new element content that is to be attached to the object 114 (e.g., element.innerHTML). When no object exists in the cache 112, a new one can be created and returned.

Sample function 154 can be used to remove an object, which can be utilized instead of a delete object function. When the function 154 executes, the referenced object can be added to the cache 112 without performing a memory deallocation action. Although not shown, existing content of the object can be optionally removed before the object is placed in the cache 114. Removing the content is unnecessary when a check is made to ensure no “old” content exists after the replace content action of function 152 executes. Although not shown, the cache handler 110 can also periodically perform cache management actions to remove “old” or expired objects 114 from the cache 112 as needed to ensure the cache has sufficient capacity to store new objects 114.

As shown herein, the Web server 130 can be any computing device capable of establishing a web session with browser 106 of computing device 104. Web server 130 can include configuration engine 132 and data store 134. Web server 130 can serve web pages 136 and associated executables 138, which can be embedded in the Web pages 136, to external computing devices, such as device 104.

In one embodiment, the Web server 130 can be a mashup server, the Web pages 136 can be mashups, and executables 138 can include widgets. Web server 130 can implement multiple widgets on a single web page and allow a user to add, remove, and rearrange the widgets. Configuration engine 132 can be an engine which can allow the configuration of aspects of web server 130's behavior, such as permitting user 102 to customize a Web page 136.

Each executable 138 can be a segment of code that dynamically generates Web content. For example, the executable 138 can utilize JAVASCRIPT, VBSCRIPT, AJAX, ECMASCRIPT, DYNAMIC HTML, and the like.

Each object 114 can be a structured object that was generated by an executable 138, which is also allocated a memory space. Each object 114 can be a set of one or more HTML elements. In one embodiment, semantic content of the objects 114 can be redacted before the object 114 is placed in the cache 112. The object 114 can include a JAVASCRIPT object, a VBScript object, an AJAX object, an ECMASCRIPT object, a DYNAMIC HTML object, and the like.

Computing device 104 can be any device in which includes an executable browser 106. For example, device 104 can include, but is not limited to, a desktop computer, a personal data assistant (PDA), a mobile phone, a kiosk, and the like.

Data stores 112 and 134 can be physically implemented within any type of hardware including, but not limited to, a magnetic disk, an optical disk, a semiconductor memory, a digitally encoded plastic memory, a holographic memory, or any other recording medium. The data stores 112 and 134 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

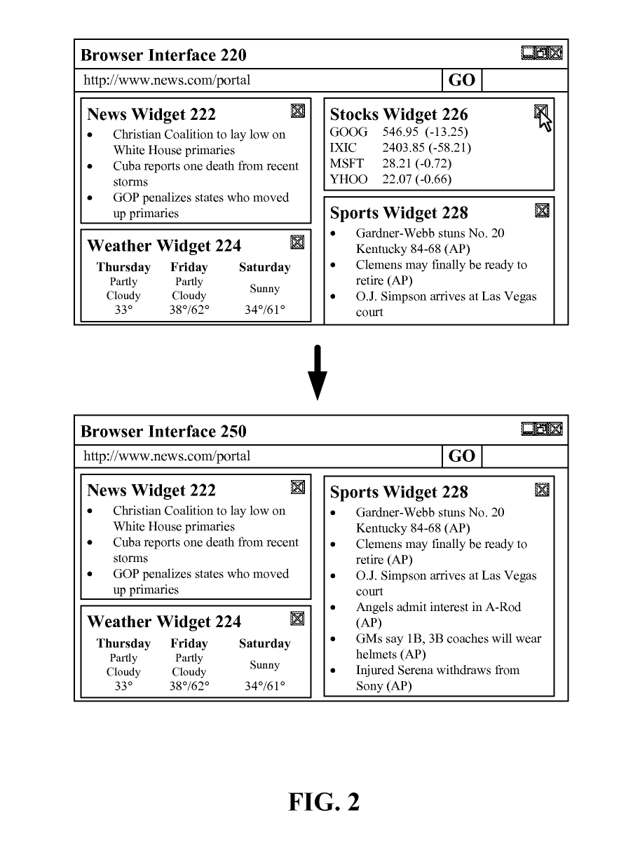

FIG. 2 illustrates interfaces 220, 250 for caching parent objects to reduce the creation/deletion time of HTML elements in accordance with an embodiment of the inventive arrangements disclosed herein. The interfaces 220, 250 can be utilized in context of system 100.

Interface 220 can illustrate a web session in which includes widgets 222-228. Interface 250 can illustrate the same web session after stocks widget 226 has been closed. Widgets 222-228 can be portable chunks of code that can be installed and executed within any separate HTML (Hypertext Markup Language) based Web page by an end user. Each widget 222-228 can contain necessary code to bring in live content from external sources. Such content can include advertisements, links, images, news, weather, and the like. News widget 222 can provide news headlines, weather widget 224 can provide weather forecasts, stocks widget 226 can provide the latest stock quotes, and sports widget 228 can provide sports new headlines.

After stocks widget 226 is closed from interface 220, the remaining widgets can be automatically re-arranged to fill the unused space, as shown in interface 250. When widget 226 is closed, the structure of the widget object can be saved to a cache. When the user wants to add a stocks widget to the interface again, the saved widget object can be recycled, rather than creating a new widget of a similar structure. Use of the object cache can increase performance by reducing the number of memory allocation and deallocation actions for HTML elements.

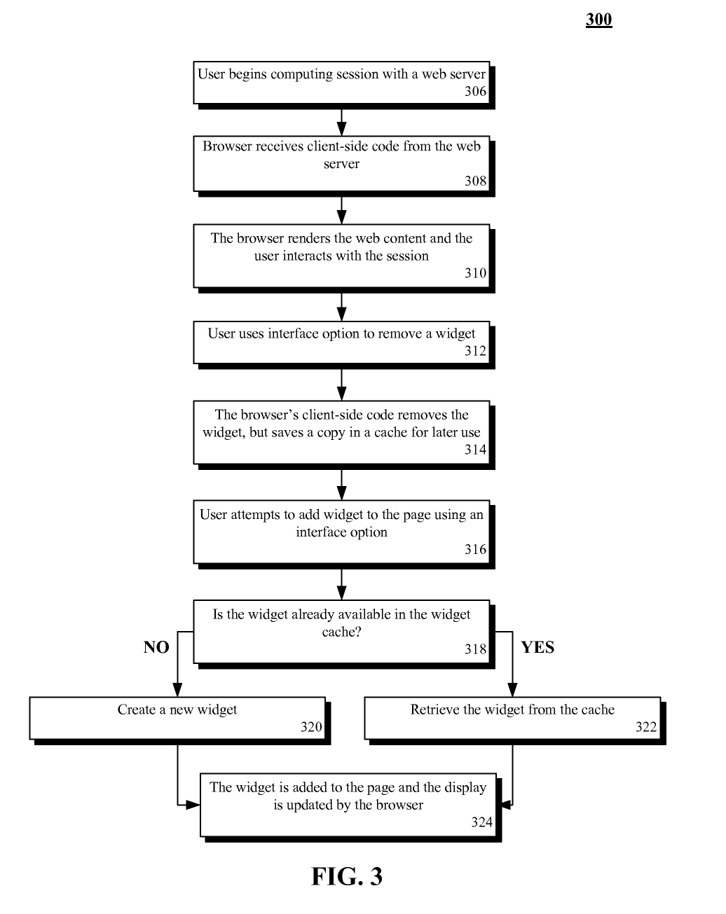

FIG. 3 is a flow chart of a method 300 for caching dynamically created Web objects contents to improve performance in accordance with an embodiment of the inventive arrangements disclosed herein. Method 300 can be performed in context of system 100. Method 300 is written so that the cached dynamic object is a widget, but other types of objects (e.g., JAVASCRIPT object) can be utilized.

Method 300 can being in step 306, where a user can begin a computing session with a Web server. In step 308, the user's browser can receive client-side code from the Web server. In step 310, the browser can render the Web content and the user can interact with the session. The session's interface can be displayed in context with the interfaces illustrated in FIG. 2. In step 312, the user uses an interface option to remove a widget. In step 314, the browser's client-side code removes the widget, but keeps its contents saved in a cache for later use. In step 316, the user can attempt to add a widget to the page using an interface option. In step 318, the client-side code determines if the widget is already available in the cache. If a widget with an appropriate structure (same as the desired widget) is already available in step 318, method 300 can continue to step 322, where the widget's can be retrieved from the widget cache. The widget's content can be replaced with desired content without having to create a new widget (which avoids memory allocation costs). If in step 318, the contents aren't already available, method 300 can continue to step 320, where a new widget can be created and initialized. After completing steps 320 or 322, method 300 can continue to and complete in step 324, where the widget is added to the page and the display is updated by the browser.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for optimizing performance of dynamic HTML element creation/deletion comprising:
detecting an event to delete a structured object of a Web page rendered in a browser, where the structured object comprises a set of at least one hyper text markup language (html) element that was dynamically created for the Web page responsive to execution of an executable computer program product; and
placing the structured object in a cache without deleting memory allocations for the structured object so that cached object is available for future use.

2. The method of claim 1, further comprising:
detecting an event to create a new object of a Web page for rendering the new object within a browser, wherein the new object is a structured objecting comprising a set of at least one HTML element that is dynamically created responsive to execution of an executable computer program product, wherein a structure of the new object is equivalent to the structure to the structure of the structured object;
retrieving the structured object from the cache;
inserting content associated with the new object into the structured object;
removing the structured object from the cache; and
utilizing the structured object as the new object.

3. The method of claim 1, further comprising:
discarding semantic content of the structured object before placing the structured object within the cache.

4. The method of claim 2, wherein the structured object and the new object are JAVASCRIPT objects, wherein the executable computer program products are written in JAVASCRIPT.

5. The method of claim 2, wherein the structured object and the new object are widgets of a Mashup.

6. The method of claim 2, wherein the structured object and the new object are portlets of a portal.

7. The method of claim 2, wherein the steps of the method are performed by a cache handler interacting with a language interpreter of a Web browser in a user transparent fashion without requiring code of the Web page provided by a Web server to be modified and without the code of the Web page explicitly specifying programmatic actions involving to the cache.

8. A computer program product for optimizing performance of dynamic HTML element creation/deletion comprising:
a computer usable medium having computer usable program code embodied therewith, the computer usable program code comprising:
computer usable program code configured to detect an event to delete a structured object of a Web page rendered in a browser, where the structured object comprises a set of at least one hyper text markup language (html) element that was dynamically created for the Web page responsive to execution of an executable computer program product; and
computer usable program code configured to place the structured object in a cache without deleting memory allocations for the structured object so that cached object is available for future use.

9. The computer program product of claim 8, further comprising:
computer usable program code configured to detect an event to create a new object of a Web page for rendering the new object within a browser, wherein the new object is a structured objecting comprising a set of at least one HTML element that is dynamically created responsive to execution of an executable computer program product, wherein a structure of the new object is equivalent to the structure to the structure of the structured object;
computer usable program code configured to retrieve the structured object from the cache;
computer usable program code configured to insert content associated with the new object into the structured object;
computer usable program code configured to remove the structured object from the cache; and
computer usable program code configured to utilize the structured object as the new object.

10. The computer program product of claim 8, further comprising:
computer usable program code configured to discard semantic content of the structured object before placing the structured object within the cache.

11. The computer program product of claim 9, wherein the structured object and the new object are JAVASCRIPT objects, wherein the executable computer program products are written in JAVASCRIPT.

12. The computer program product of claim 9, wherein the structured object and the new object are widgets of a Mashup.

13. The computer program product of claim 9, wherein the structured object and the new object are portlets of a portal.

14. The computer program product of claim 9, wherein programmatic actions for which the computer usable program code is configured are performed by a cache handler interacting with a language interpreter of a Web browser in a user transparent fashion without requiring code of the Web page provided by a Web server to be modified and without the code of the Web page explicitly specifying programmatic actions involving to the cache.

15. A Web browser comprising:
a language interpreter configured to receive content from a Web server to be rendered within a Web browser instance, wherein the language interpreter is configured to utilize the cache handler when dynamically creating and deleting structural HTML elements;
a cache handler configured to selectively place structural HTML elements for which memory has been allocated and that were dynamically created within a cache instead of deleting these structural HTML elements when the structural HTML elements are no longer immediately needed by the Web browser instance, wherein said cache handler is further configured to query the cache when a new dynamically created structural HTML element is needed, to utilize a cached element when one of equivalent structure is found during the query instead of creating a new HTML element that requires memory to be allocated, and to replace content of a cached element with content associated with a desired structural HTML element when retrieving an element from said cache.

16. The Web browser of claim 15, wherein the cache handler is built into the language interpreter.

17. The Web browser of claim 15, wherein the structural HTML elements that are cached are JAVASCRIPT objects.
